(19) United States
(12) Patent Application Publication
(10) Pub. No.: US 2006/0129972 A1
(43) Pub. Date: Jun. 15, 2006

(54) Application developer and method for generating platform independent code

(76) Inventors: John Christopher Tyburski, Jonesboro, GA (US); Miguel A. Mendez, Roswell, GA (US); John Andrew Yeager, Atlanta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/000,574

(22) Filed: Nov. 30, 2004

(51) Int. Cl. G06F 9/44

(52) U.S. Cl. 717/106

(57) ABSTRACT

A method for developing platform independent applications comprises integrating an interface into a software development platform, receiving an input indicative of a desired mobile-device type designated to receive an application responsive to the platform independent code, enabling a user to develop an instruction set via the interface, generating a set of platform independent files responsive to the mobile-device type and the instruction set, forwarding the set of platform independent files to a device translator, and generating a device-specific application responsive to the mobile-device type and the platform independent files. A computing device exposes the functions of a software development platform, generates a representation of a set of instructions designated for execution on a mobile device, and transforms the representation. The mobile device receives a device independent representation of an application program designated for operation on the mobile device along with an application program.

### FIELD OF THE INVENTION

The present invention relates generally to an application development tool. In particular, an application development tool that can be integrated with a commercially available software development application that enables software engineers to create mobile-device independent software solutions.

### BACKGROUND

The need for mobile computing and network connectivity is among the main driving forces behind the evolution of computing devices today. The desktop personal computer (PC) has been transformed into the portable notebook computer. More recently, a variety of mobile handheld consumer electronic devices, including personal digital assistants (PDAs), cellular phones and intelligent pagers have acquired relatively significant computing ability. In addition, other types of mobile consumer devices, such as digital television set-top boxes, also have evolved greater computing capabilities. Network connectivity is quickly becoming an integral part of these consumer devices as they begin communicating with each other and traditional server computers via various data communication networks, such as a wired or wireless local area network (LAN), cellular, Bluetooth, 802.11b (Wi-Fi) wireless, and general packet radio service (GPRS) mobile telephone networks, etc.

The evolution of mobile computing devices has had a significant impact on the way people share information and is changing both personal and work environments.

Traditionally, since a PC was fixed on a desk and not readily movable, it was possible to work or process data only at places where a PC with appropriately configured software was found. Presently, the users of mobile computing devices can capitalize on the mobility of these devices to access and share information from remote locations at their convenience. A highly anticipated and powerful method for sharing information across a network of computers and mobile devices is via an interface for displaying dynamically generated content.

However, mobile devices pose several challenges for application developers.

For example, mobile devices typically have more limited hardware resources than conventional computers. In addition, mobile devices tend to have widely varying hardware configurations, including differences in computation power, memory size, display capability, means for inputting data, etc. Mobile communication networks also experience limited network bandwidth and network availability. Consequently, mobile devices may be intermittently connected or disconnected from a network.

Therefore, the first generation mobile devices typically were request-only devices or devices that could merely request services and information from more intelligent and resource rich server computers. The servers used standard software architectures, such as the Java 2 enterprise edition (J2EE) platform. The server platforms could define and support a programming model that allows thin-client applications to invoke logic instructions that execute on the servers.

Today, with the advent of more powerful computing platforms aimed at mobile computing devices, such as Pocket PC® and Java 2 platform, micro edition (J2ME), mobile devices have gained the ability to host and process information and to participate in more complex interactive transactions. Pocket PC® is the registered trademark of Thaddeus Computing, Inc., Fairfield, Iowa, U.S.A. Pocket PC is also a product name used by the Microsoft Corporation of Redmond, Wash., U.S.A. to describe mobile devices. However, today's more powerful computing platforms do not address problems for developing mobile-device application software caused by the widely varying operating systems, application interfaces, user input interfaces, data display types and sizes, memory sizes, etc. across many different mobile-device types.

Therefore, in the area of mobile application environments for mobile devices there continues to be a need for a more robust application development environment that offers improved services to support mobile application development.

### SUMMARY

An embodiment of a computing device includes a processor and a memory. The memory includes logic configured to expose the functions of a software development platform to a user of the computing device responsive to an intermediate language source and configuration options associated with a mobile device remote from the computing device, generate a virtual machine instruction format representation of a set of instructions designated for execution on the mobile device, transform the configuration options and virtual machine instruction format representation into a data portion and identify native code responsive to a mobile-device type, and package the data portion and the native code to generate a mobile-device specific application.

An embodiment of a method for developing platform independent code comprises integrating an interface into a software development platform, receiving an input indicative of a first developer desired mobile-device type designated to receive an application responsive to the platform independent code, the mobile-device type identifying an operator interface on the mobile device, enabling a user to develop an instruction set via the interface and the software development platform, generating a set of platform independent files responsive to the mobile-device type and the instruction set, forwarding the set of platform independent files to a device translator configured to identify configuration options and native code responsive to the mobile-device type to a first device-specific packager, and using the first device-specific packager to generate a device-specific application responsive to the mobile-device type and the platform independent files.

### BRIEF DESCRIPTION OF THE DRAWINGS

Embodiments of a computing device and methods for developing platform independent code are illustrated by way of example and not limited by the implementations depicted in the following drawings. The components in the drawings are not necessarily to scale. Emphasis instead is placed upon clearly illustrating the principles of the present computing device and associated methods for developing platform independent code. Moreover, in the drawings, like reference numerals designate corresponding parts throughout the several views.

FIG. 1 is a schematic diagram illustrating an embodiment of a software development environment.

FIG. 2 is a schematic diagram illustrating an embodiment of the mobile device of FIG. 1.

FIG. 3 is a functional block diagram illustrating an embodiment of the computing device of FIG. 1.

FIG. 4 is a functional block diagram illustrating an embodiment of software components operable on the computing device of FIG. 2.

FIG. 5 is a flow diagram illustrating an embodiment of a method for developing platform independent code.

FIG. 6 is a flow diagram illustrating an alternative embodiment of a method for developing platform independent code.

### DETAILED DESCRIPTION

The proliferation of mobile consumer electronic devices, including personal digital assistants (PDAs), cellular phones, media players, intelligent pagers, and the like, have created a need for specialized computing skills to produce device specific applications to operate and extend the usefulness of the devices. Mobile electronic devices employ a wide variety of operating systems, application interfaces, user-input interfaces, data display types and sizes, memory sizes, etc. The variety in device architectures, functions, and data transfer methods coupled with limited application storage capacity has created an ever-increasing number of device specific applications across many different mobile-device types.

The present computing device and methods for developing platform independent code leverage the capabilities of a commercially-available software development platform and the skills of software developers familiar with its use to produce a device independent representation of an application targeted for operation on mobile-device platforms. A computing device configured with plug-in, file translator, device translator, and packaging modules generates mobile-device specific application programs. The plug-in cooperates with the software development platform to expose the various functions and features of the software development platform to software engineers.

A software engineer uses the combination of the software development platform and the plug-in to generate an instruction set (i.e., a program) that the engineer desires to execute on one or more mobile devices. The mobile devices may employ vastly different operating systems, user interfaces, and memory management techniques. The plug-in receives configuration options specific to the user interface of a select mobile device from a device translator module configured for the select mobile device. The plug-in, in combination with the software development platform presents the various configuration options to the engineer. The software engineer enters a series of instructions corresponding to the desired application to be executed on the mobile device. Once the instruction set has been completed, the software engineer directs the combination of the software development platform and the plug-in to forward the instruction set to the file translator. The file translator converts the instruction set into an intermediate representation of the instruction set that comprises a set of platform independent files. The platform independent files include resource string pool, resource property pool, reference, and code files.

The platform independent files are controllably directed to one or more device translators. The device translators work with a packager module to produce a combination including a device-specific application and platform independent data.

Each device translator is configured to verify the platform independent files as they are received and forward the configuration options used in developing the instruction set to the packager module. The device translator also forwards a link to a mobile-device specific launcher (i.e., stub code) to the packager module. The mobile device specific launcher is native code configured to make the device-specific application look like an application to the mobile device. The launcher is configured with the platform independent data and works with a pre-installed client on a mobile device. When executed on the mobile device, the launcher instructs the device how to execute the application code packaged in the platform independent files.

Each device translator includes a link to or a copy of a native language launcher.

For example, if the instruction set is designated for an application on a Palms brand device, the platform independent files are forwarded to a device translator configured to generate Palms applications. The Palms device translator includes a link to a Palms) launcher. The launcher is programmed to find a proprietary run time environment configured to execute the code in the code file within the set of platform independent files.

An embodiment of a mobile device includes one or more mechanisms for receiving device specific application programs from the computing device. The mobile-device application transfer mechanism can include a wired or wireless communication link. Any of a number of communication protocols can be used to communicatively couple a particular mobile device with the computing device or network coupled communication devices. In some implementations, the mobile-device specific application is stored in a data store coupled to a wide area network that can be accessed, downloaded and installed by operators of the target mobile device. In other embodiments, the mobile device receives application programs and perhaps other data from portable media introduced to a media interface (e.g., a reader) coupled to the mobile device.

Once the package including the launcher, device-specific application, and the platform independent data representation are installed on a particular mobile device, the launcher can be executed. The launcher finds and loads a previously installed application client on the mobile device. The launcher then turns over the platform independent representation to the previously installed client. The client is a platform and run time that includes a virtual machine, components, libraries, etc. The client executes the application in accordance with virtual machine code from the one or more code files produced by the file translator.

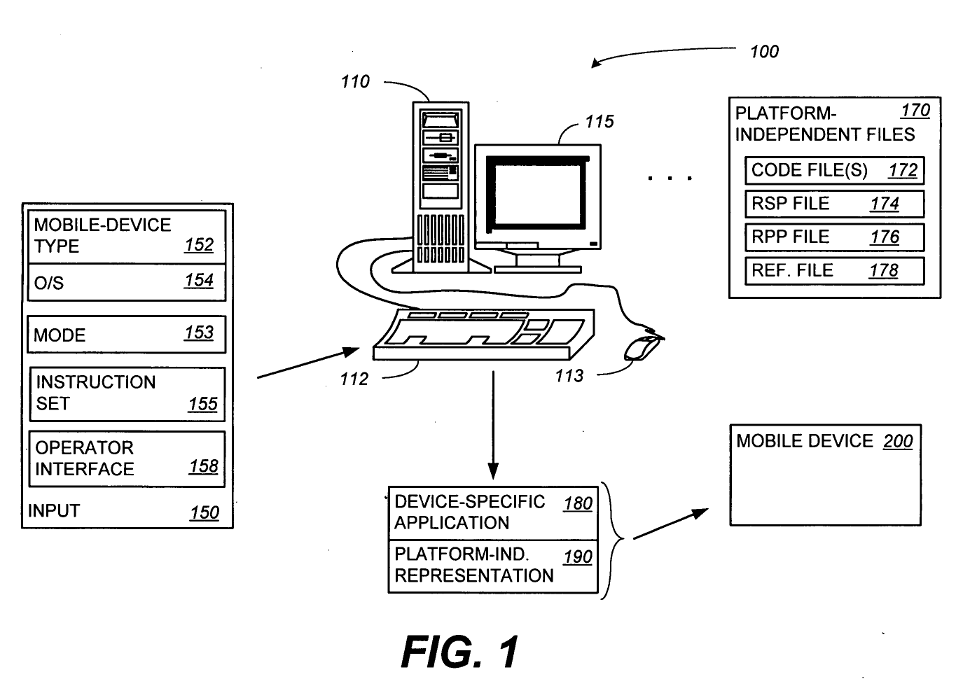

Reference will now be made in detail to the description of example embodiments of the systems and methods for generating platform independent code as illustrated in the drawings. FIG. 1 is a schematic diagram illustrating an embodiment of a software development environment 100. In the example, computing device 110 is a desktop computer or personal computer. Computing device 110 is associated with monitor 115, keyboard 112 and mouse 113.

As illustrated in FIG. 1, computing device 110 operates in accordance with inputs 150 entered by a software developer (not shown). Inputs 150 include one or more indicators that identify a mobile-device type 152, operating system 154, operator interface 158, and mode 153. Mobile-device types define multi-mode multi-function PDAs, cellular phones, pagers, media players, and other remote devices. Operating systems include those systems that direct the operation of one or more functions on mobile devices such as but not limited to Palm OS®, Pocket PC®, Symbian® OS, etc. Palm OS® is a registered trademark of Palm Computing, Inc. of Mountain View, Calif., U.S.A. Symbian® is a U.S. registered trademark of Symbian Ltd., of London, United Kingdom. An operator interface is defined by the combination of elements that receive user inputs and provide information to a user of a particular mobile device. Note that in some cases identification of a mobile-device type may include an identification of an associated operator interface and operating system that are implemented on the mobile device.

At least two modes are envisioned. A software developer selects a mode via mode input 153. In a first mode, a software developer enters instructions directed to perform a common data handling process such as generating a mathematical combination of two or more numbers represented in storage registers. Under this first mode, the software developer instructs the software development platform how to perform the associated function. In a second operating mode, a software developer enters instructions that generically describe an input/output operation as reflected on a display device. For example, the software developer may wish to describe one or more pushbuttons or touch sensitive portions of an entry display that correspond to respective alphanumeric characters, mathematical operators, or other designated functions. A software developer working in this second operational mode will be generating instructions in accordance with the input/output interfaces available on a designated mobile device.

Instruction set 155 is a first abstraction of an application program that is intended to be executed on a designated mobile device 200. A software developer using keyboard 112 and mouse 113, and perhaps other input devices (not shown) associated with computing device 110, enters the individual instructions that comprise the instruction set 155. A representation of the entered instructions forming the instruction set 155, the instruction set 155, or both may be rendered and displayed to provide real-time feedback to the developer. Once the software developer is satisfied with the entered instruction set 155, the developer directs computing device 110 to generate a device-specific application 180 and a platform independent representation of the instruction set 190. As illustrated in FIG. 1, computing device 110 generates an intermediate abstraction of the instruction set in platform independent files 170. Platform independent files 170 include one or more code files 172, a resource string pool (RSP) file 174, a resource property pool (RPP) file 176, and a reference file 178.

RSP file 174 includes each of the label strings associated with various elements on a mobile-device interface. RPP file 176 includes a description of various functional elements such as a pushbutton or a portion of a touch sensitive interface. Descriptors include size, color, shape, operation(s), etc. associated with each functional element described by the developer. Reference file 178 includes any desired functional modules that are not part of a standard mobile-device run time environment. For example, a functional module that interprets a bar code is generally not part of the standard run time environment on a mobile device. Such a module resident on computing device 110 can be identified by reference file 178. Code files 172 include instructions for directing a virtual machine on mobile device 200. As described above, a target mobile device will be configured with an independent application (i.e., a client) that includes a virtual machine and a runtime.

Computing device 110 uses the intermediate abstraction of the instruction set 155 in the platform independent files 170 and generates device-specific application 180 and platform independent representation 190. Device-specific application 180 is communicated to a respective mobile device 200 for subsequent execution on the device. Platform independent representation 190 is a data file that includes information extracted from the platform independent files 170. Platform independent representation 190, which may be stored separate from device-specific application 180 can be used by the combination of a device specific translator and a packager module (not shown) within computing device 110 to generate a second device-specific application intended for a different mobile device without generating an additional instruction set 155.

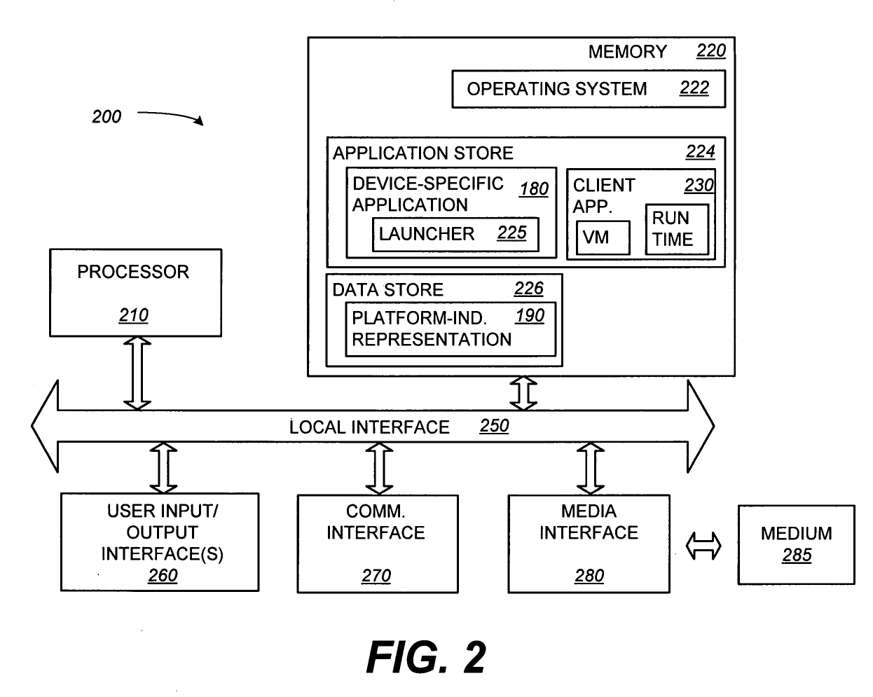

FIG. 2 is a schematic diagram illustrating an embodiment of the mobile device 200 of FIG. 1. Mobile device 200 includes a processor 210, memory 220, user input/output interface(s) 260, communication interface 270, and media interface 280 that are communicatively coupled via local interface 250. Local interface 250 can be, for example but not limited to, one or more buses or other wired or wireless connections, known or later developed. Local interface 250 may have additional elements, which are omitted for simplicity, such as controllers, buffers (caches), drivers, repeaters, and receivers, to enable communications. Further, local interface 250 may include address, control, and/or data connections to enable appropriate communications among the aforementioned components of mobile device 200.

In the embodiment of FIG. 2, the processor 210 is a hardware device for executing software stored in memory 220. Processor 210 can be any custom-made or commercially available processor, a central-processing unit (CPU) or an auxiliary processor among several processors associated with mobile device 200, and a semiconductor-based microprocessor (in the form of a microchip). In other embodiments, processor 210 can be an application specific integrated circuit (ASIC) or a field programmable gate array (FPGA) configured to execute various logic in accordance with one or more operator inputs entered via user input/output interfaces 260 and data within memory 220.

Memory 220 can include any one or a combination of volatile memory elements (e.g., random-access memory (RAM), such as dynamic-RAM or DRAM, static-RAM or SRAM, etc.) and nonvolatile-memory elements (e.g., read-only memory (ROM), erasable programmable read-only memory (EPROM), electrically erasable programmable read-only memory (EEPROM), etc.). Moreover, memory 220 may incorporate electronic, magnetic, optical, and/or other types of storage media now known or later developed. Note that the memory 220 can have a distributed architecture, where various components are situated remote from one another, but accessible by processor 210.

The software in memory 220 may include one or more separate programs, each of which comprises an ordered listing of executable instructions for implementing logical functions. In the example of FIG. 2, memory 220 includes an application store 224 and a data store 226. Application store 224 stores application programs suited for execution on mobile device 200. Application store 224 includes device-specific application 180 generated by the above described application developer and a separate client application 230. Device-specific application 180 includes launcher 225. Launcher 225, as described above, is native code to the operating system 222 on mobile device 200. Client application 230 is located and accessed by launcher 225. Client application 230 includes a virtual machine and run time operable on mobile device 200. Launcher 225 forwards the instruction codes and platform-independent representation 190 that direct client 230 how to execute the device-specific application on mobile device 200. Application store 224 may further include one or more commercially available applications as well as proprietary applications (not shown). Data store 226 includes a platform independent data representation 190 that reflects an instruction set entered by an operator of the computing device 110 (FIG. 1) and the platform independent files 170 generated by the computing device 110. In an alternative embodiment, platform independent data representation 190 may be packaged with the device-specific application in the application store 224.

Memory 220 further includes operating system 222. Operating system 222 controls the execution of applications, such as device-specific application 180 and provides scheduling, input-output control, memory management, and communication control and related services.

User input/output interface(s) 260 enable an operator of the mobile device to enable one or more functions, input data, and receive results in accordance with the specifics of the device interfaces and the underlying applications including device-specific application 180. User input/output interfaces 260 include, but are not limited to, a touch-sensitive screen, one or more graphical displays such as a liquid crystal display (LCD), a plasma display, or other display types now known or later developed.

A graphical interface, when implemented with the mobile device, operates in association with multi-function pushbuttons, one or more switches associated with specified device functions, other interactive-pointing devices, voice-activated interfaces, or other operator-machine interfaces (omitted for simplicity of illustration) now known or later developed. Note that each mobile-device type may not include each of the aforementioned interfaces.

Communication interface 270 can include an infrared (IR) sensitive transceiver, a radio-frequency (RF) transceiver, a serial port, a parallel port, etc. for communicatively coupling mobile device 200 to external devices. Communication interface 270 can be selectively in communication with processor 210 and/or memory 220 via local interface 250. A variety of wireless communications interfaces and data transfer protocols support the communication of information both to and from mobile devices such as PDAs, pagers, cellular phones, etc. to an appropriately configured source or destination device, respectively. For example, infrared data association protocol (IrDA), wireless fidelity (IEEE 802.11b wireless networking) or Wi-Fi, Bluetooth®, etc. each support wireless data transfers. Bluetooth® is the registered trademark of Bluetooth SIG, Inc.

Media interface 280 is also selectively in communication with processor 210 and memory 220 to receive both data and one or more application programs including device-specific application 180. As illustrated in FIG. 2, media interface 280 is configured to receive one or more portable data storage media such as medium 285. It should be understood that various I/O device(s) in addition to those described above may also be integrated via local interface 250 and/or other interfaces (not shown).

When the mobile device 200 is in operation, processor 210 is configured to execute software stored within the memory 220, to communicate data to and from the memory 220, and to generally control operation of the mobile device 200 pursuant to the software. The operating system 222 and applications, in whole or in part, but typically the latter, are read by the processor 210, perhaps buffered within the processor 210, and then executed.

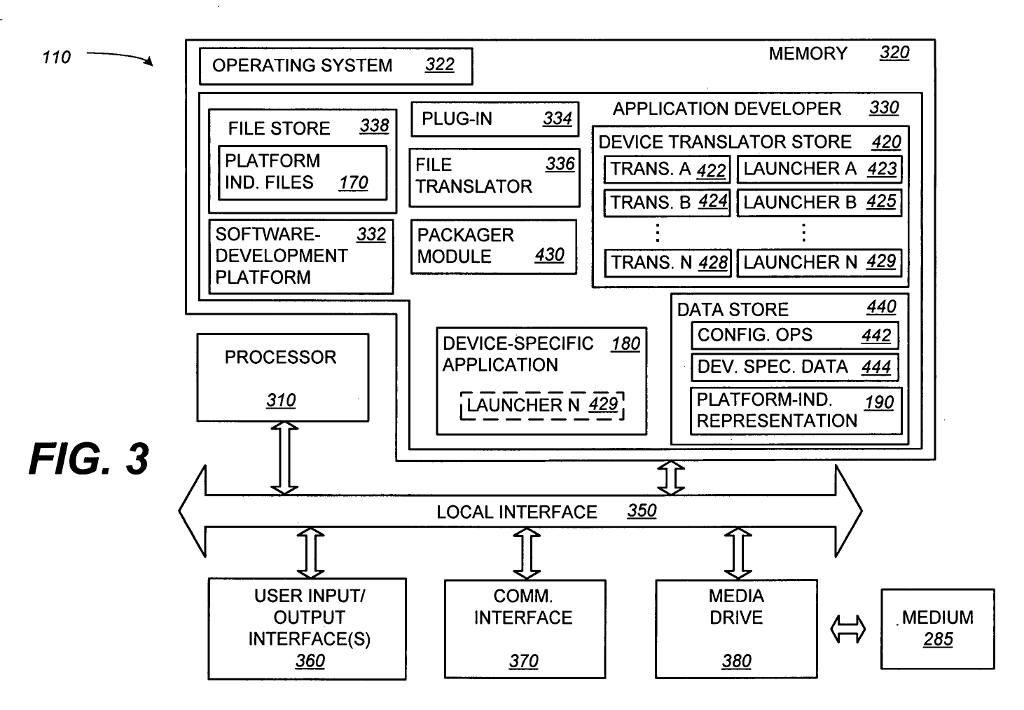

FIG. 3 is a functional block diagram illustrating an embodiment of the computing device 110 of FIG. 1. Computing device 110 includes a processor 310, memory 320, user input/output interface(s) 360, communication interface 370, and media interface 380 that are communicatively coupled via local interface 350. Local interface 350 can be, for example but not limited to, one or more buses or other wired or wireless connections, known or later developed. Local interface 350 may have additional elements, which are omitted for simplicity, such as controllers, buffers (caches), drivers, repeaters, and receivers, to enable communications. Further, local interface 350 may include address, control, and/or data connections to enable appropriate communications among the aforementioned components of computing device 110.

In the embodiment of FIG. 3, the processor 310 is a hardware device for executing software stored in memory 320. Processor 310 can be any custom-made or commercially available processor, a central-processing unit (CPU) or an auxiliary processor among several processors associated with computing device 110, and a semiconductor-based microprocessor (in the form of a microchip).

The memory 320 can include any one or combination of volatile memory elements (e.g., RAM, DRAM, SRAM, etc.) and nonvolatile-memory elements (e.g., ROM, EPROM, EEPROM, etc.). Moreover, the memory 320 may incorporate other types of storage media now known or later developed such as floppy-disk drives, hard-disk drives, portable media drives, a redundant array of inexpensive disks (RAID) device, etc. Note that the memory 320 can have a distributed architecture, where various components are situated remote from one another, but accessible by processor 310.

The software in memory 320 may include one or more separate programs, each of which comprises an ordered listing of executable instructions for implementing logical functions. In the example of FIG. 3, the software in the memory 320 includes operating system 322 and an application developer 330. The application developer 330 comprises various functional modules executed by computing device 116 (FIG. 1). The application developer 330 includes software development platform 332, plug-in 334, file translator 336, device translator store 420, and packager module 430. As further illustrated in FIG. 3, memory 320 includes file store 338, data store 440, and other data items such as device-specific application 180.

As described above, plug-in 334 cooperates with the software development platform 332 to expose the various functions and features of the software development platform 332 to software engineers. A software engineer uses the combination of the software development platform 332 and plug-in 334 to generate instruction set (i.e., a program) that the engineer desires to execute on one or more mobile devices. Plug-in 334 receives configuration options 442 specific to the user interface of a select mobile device from a device translator module (e.g, device translator A 422, device translator B 424, device translator N 428) configured to generate a device-specific application 180 executable on a select mobile device. The plug-in 334, in combination with the software development platform 332 present the various configuration options 442 to the engineer. The combination stores device specific data 444 in data store 440.

The software engineer enters a series of instructions corresponding to the desired application to be executed on the mobile device. Once the instruction set 155 has been completed, the software engineer directs the combination of the software development platform 332 and the plug-in 334 to forward the instruction set 155 to file translator 336. The file translator 336 converts the instruction set 155 into an intermediate representation of the instruction set that comprises a set of platform independent files 170.

The platform independent files 170 are controllably directed to one or more device translators in device translator store 420. The device translators work with packager module 430 to produce a combination including a device-specific application 180 and a platform independent representation 190. Each device translator is configured to verify the platform independent files 170 as they are received and forward the configuration options 442 used in developing the instruction set 155 to the packager module 430. Each device translator (device translator A 422, device translator B 424, and device translator N 428) also forwards a link to a mobile-device specific launcher (i.e., stub code) to the packager module 430. The mobile device specific launcher (e.g., launcher A 423, launcher B 425, launcher N 429) is native code configured to make the device-specific application 180 look like an application to the mobile device 200. In the illustrated embodiment, launcher N 429 is configured in a package with the platform independent representation 190. The package works with a pre-installed client 230 (FIG. 2) on a mobile device 200. When executed on the mobile device 200, launcher N 429 instructs the mobile device 200 how to execute the application code packaged in the platform independent files 170.

In an embodiment, application developer 330 is one or more source programs, executable programs (object code), scripts, or other collections each comprising a set of instructions to be performed. The sample embodiment illustrated in FIG. 3 shows file store 338, data store 440 (including configuration options 442, device-specific data 444), device-specific application 180, and the contents thereof integrated within application developer 330. It should be understood that these items, produced by the application developer 330, may be stored within memory devices other than memory 320 that are communicatively coupled to processor 310.

Operating system 322 preferably controls the execution of software modules associated with software development platform 332, plug-in 334, file translator 336, device translator store 420, and packager module 430. In addition, operating system 322 provides task scheduling, input-output control via user I/O interface(s) 360, communication interface 370, and media drive 380, memory management, and related services.

User I/O device interface(s) 360 includes one or more controllers configured to communicate with functional pushbuttons on a keyboard, interactive-pointing devices, voice-activated interfaces, or other operator-machine interfaces (omitted for simplicity of illustration) now known or later developed.

Communication interface 370 can include an infrared (IR) sensitive transceiver, a radio-frequency (RF) transceiver, a serial port, a parallel port, a modem, etc. for communicatively coupling computing device 110 to external devices.

Communication interface 370 can be selectively in communication with processor 310 and/or memory 320 via local interface 350. A serial port, such as one provided on a universal serial bus, can be used to communicate with a number of external devices via a suitably configured connector and cable. A parallel port can be used to communicate with various hard copy generators such as printers and plotters. A modem can be used to establish and support LAN and/or wide area network (WAN) communications.

Media drive 380 is also selectively in communication with processor 310 and memory 320 to deliver and receive both data and one or more application programs including device-specific application 180. As illustrated in FIG. 3, media drive 380 is configured to receive one or more portable data-storage media such as medium 285. Medium 285 is a computer-readable medium. It should be understood that various I/O device(s) in addition to those described above may also be integrated via local interface 350 and/or other interfaces (not shown).

It should be understood that plug-in 334, file translator 336, device translators (e.g., device translator A 422, device translator B 424, device translator N 428), and packager module 430 including functional items therein, such as the device-specific application 180, the platform independent representation 190, and the files in file store 338 can be embodied in any computer-readable medium for use by or in connection with an instruction-execution system, apparatus, or device, such as a computer-based system, processor-containing system, or other system that can fetch the instructions from the instruction-execution system, apparatus, or device, and execute the instructions. In the context of this disclosure, a “computer-readable medium” can be any means that can store, communicate, propagate, or transport a program for use by or in connection with the instruction-execution system, apparatus, or device. The computer-readable medium can be, for example but not limited to, an electronic, magnetic, optical, electromagnetic, infrared, or semiconductor system, apparatus, device, or propagation medium now known or later developed. Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Those skilled in the art will understand that various portions of the application developer 330 can be implemented in hardware, software, firmware, or combinations thereof. In separate embodiments, plug-in 334, file translator 336, device translators 422, 424, 428, and packager module 430 are implemented using a combination of hardware and software or firmware that is stored in memory 320 and executed by a suitable instruction-execution system. If implemented solely in hardware, as in an alternative embodiments, plug-in 334, file translator 336, device translators 422, 424, 428, and packager module 430 can be separately implemented with any or a combination of technologies which are well-known in the art (e.g., discrete-logic circuits, application-specific integrated circuits (ASICs), programmable-gate arrays (PGAs), field-programmable gate arrays (FPGAs), etc.), and/or later developed technologies. In preferred embodiments, the functions of the plug-in 334, file translator 336, device translators 422, 424, 428, and packager module 430 are implemented in a combination of software and data executed and stored under the control of the computing device 110 (FIG. 1). It should be noted, however, that plug-in 334, file translator 336, device translators 422, 424, 428, and packager module 430 are not dependent upon the nature of the underlying computing device and/or upon the operating system in order to accomplish their respective designated functions.

It will be well understood by one having ordinary skill in the art, after having become familiar with the teachings of the application developer 330 and the methods for producing platform independent code that plug-in 334, file translator 336, device translators 422, 424, 428, and the packager module 430 may be written in a number of programming languages now known or later developed.

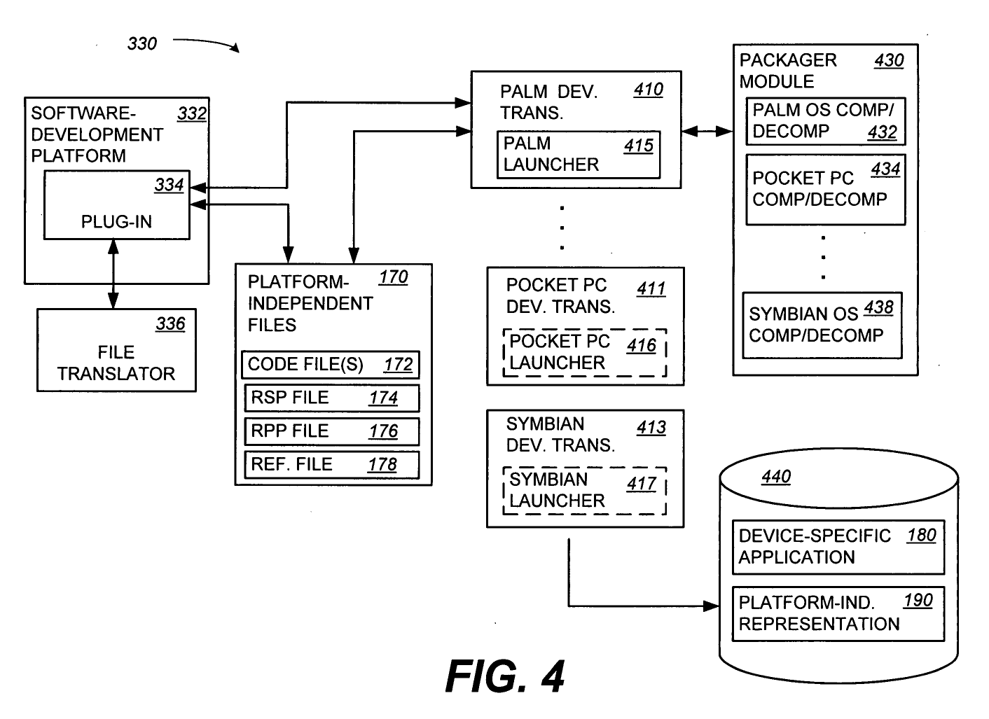

FIG. 4 is a functional block diagram illustrating an embodiment of application developer 330 (i.e., software modules) operable on the computing device 110 of FIG. 1.

As illustrated in FIG. 4, software development platform 332 is associated with plug-in 334. Plug-in 334 receives configuration options (not shown) from one or more device translators. Plug-in 334 exposes the functionality of the software development platform 332 to an operator of computing device 110 (FIG. 1) such that a software engineer familiar with the software development platform 332 can develop device-specific applications 180 (FIG. 1) for execution on one or more mobile devices 200 (FIG. 1).

Upon the direction of a software engineer, plug-in 334 forwards instruction set 155 (FIG. 1) to file translator 336, which generates platform independent files 170 responsive to an intermediate language in a virtual machine instruction format. As described above, the virtual machine is associated with client 230 and operable on mobile device 200.

In turn, the platform independent files 170 are sent to a device translator, responsive to a select mobile-device type. In the example, shown in FIG. 4, the platform independent files 170 are forwarded to Palm® device translator 410. Palm® device translator 410 provides one or more services and provides a link or other suitable reference to Palm® launcher 415, which together generate a representation of a generic interface for a Palm® device. The representation produced by Palm® device translator 410 is still not in a format that will be recognized as an application program on a Palm® type mobile device. The packager module 430 is used to assist the device translator(s) in producing a combination including a device-specific application 180 and platform-independent representation 190. Each device translator is configured to verify the platform independent files 170 as they are received and forward the configuration options 422 (not shown) used in developing the instruction set 155 to the packager module 430. Each device translator also forwards a link to a mobile-device specific launcher (i.e., stub code) to the packager module 430. As further illustrated in FIG. 4, the combination of the Palm® device translator 410 and the packager module 430 generate a package including the device-specific application 180 and platform-independent representation 190. The package parts are then stored in data store 440.

Application developer 330 includes optional device translators such as Pocket PC® device translator 411 and Symbian® device translator 413 for generating additional representations of the information provided in the platform independent files 170. Alternatively, these or additional device translators (not shown) may be employed by application developer 330 to generate additional representations responsive to the platform independent data representation 190. Packager module 430 includes additional operating system specific composer/decomposers such as Pocket PC® composer/decomposer 434 and Symbian® OS composer/decomposer 438 to generate Pocket PC® and Symbian® specific application programs.

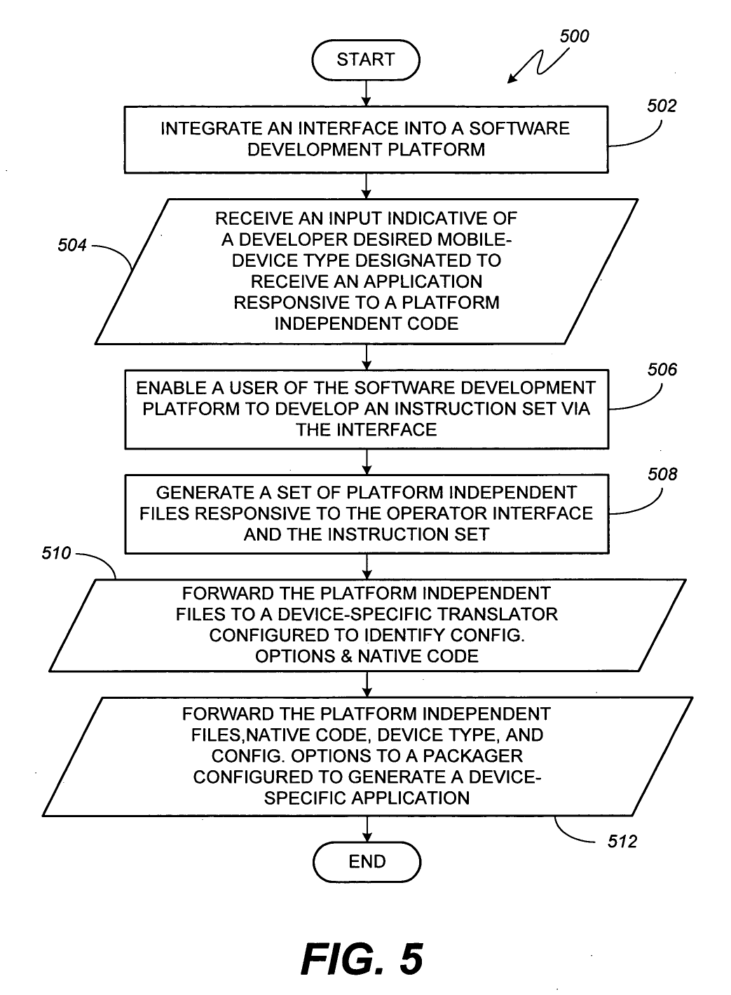

FIG. 5 is a flow diagram illustrating an embodiment of a method 500 for developing platform independent code. Method 500 begins with block 502 where an interface is integrated into a software development platform. In some implementations, the interface is a plug-in. The interface establishes a connection between the software development platform and functions or utilities directed to human device interfaces on various mobile devices. After the interface is integrated with the software development platform, an input indicating a developer desired mobile-device type is received as indicated in input/output block 504. The identified mobile-device type is the target recipient for the later developed device specific application. As indicated in block 506, the developer uses the combination of the software development platform and the plug-in to create an instruction set.

Once the developer is satisfied with the instruction set created in block 506, the developer directs a suitably configured computing device (e.g, computing device 110) to generate a set of platform independent files responsive to the instruction set, as shown in block 508. Method 500 continues by forwarding the platform independent files to a device-specific translator configured to identify configuration options and native code, as indicated in input/output block 510. Next, as shown in input/output block 512, the device-specific translator forwards the platform independent files, native code, device type, configuration options and perhaps additional data as may-be required to generate a device-specific application program to a packager configured to generate a device specific application responsive to the mobile-device type and the platform independent files. The device-specific application program can then be transferred to a temporary storage device for download and installation on one or more of the target mobile devices. Alternatively, the device-specific application can be stored on a portable data storage device for transfer and installation to a target mobile device.

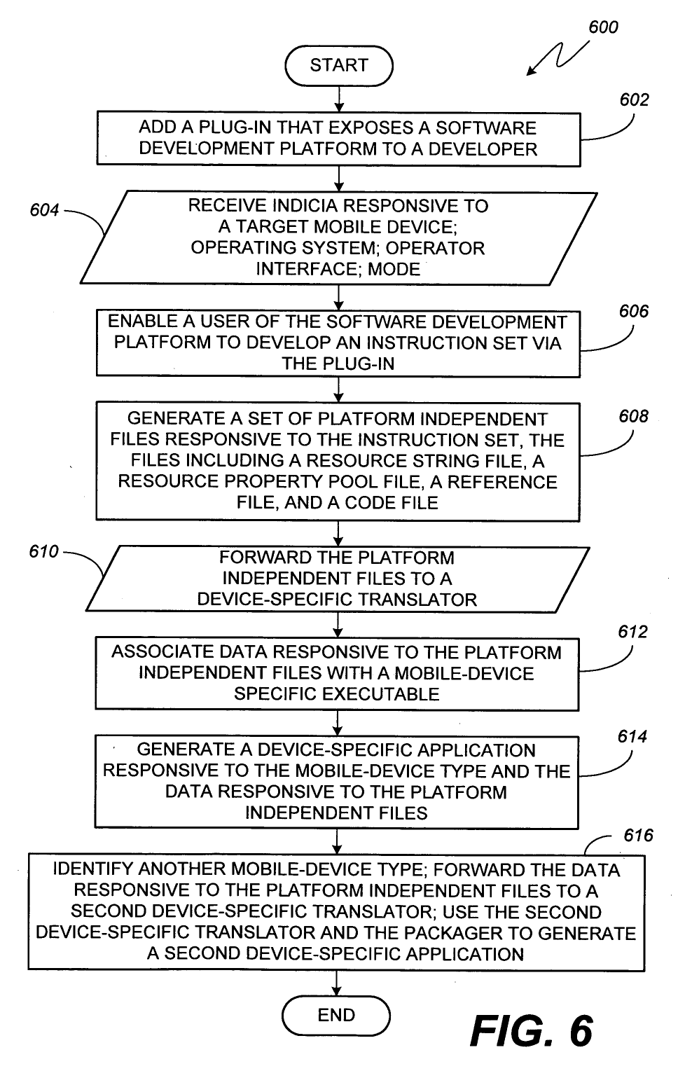

FIG. 6 is a flow diagram illustrating an alternative embodiment of a method for developing platform independent code. Method 600 begins with block 602 where a plug-in is added to a software development platform to expose the functions and interfaces of the software development platform to an operator of the application developer. As indicated in input/output block 604, the operator provides indicia responsive to a desired target mobile-device type, operating system, user interface, and operational mode. In block 606, the operator uses the software development platform and plug-in to generate an instruction set. Once the operator is satisfied with the instruction set, the operator controllably directs the application developer to generate a set of platform independent files responsive to the instruction set, as indicated in block 608. The platform independent files may include a resource string file, a resource property file, a reference file and a code file. Note that not all platform independent applications will require all four, file types. For example, when a previously installed client on the mobile device includes a run time having all code and resources necessary to complete desired functions it is not necessary for the platform independent applications to include a representation of a reference file.

The resource string file includes each of the label strings to be applied to various elements on the mobile-device interface. Typical label strings for functions on a mobile device include “ON/OFF,” “MENU,” “CLEAR,” “TALK,” “END,” as well as additional alphanumeric indicators. The resource property file includes a description of various functional elements such as a pushbutton or a portion of a touch sensitive interface. For example, a resource property file may identify a particular pushbutton, associate the pushbutton with one of the label strings, and identify a desired response from a mobile device. The reference file includes any desired functional modules that are not part of a standard mobile-device run time environment. For example, the reference file may include a bar code scanner module. The code file includes instructions directed to executing a virtual machine on the computing device housing the application developer.

As shown in input/output block 610, the platform independent files are forwarded to a device-specific translator in response to the device type indicated in input/output block 604. In input/output block 612, the application developer generates and associates a data representation responsive to the platform independent files along with a device-specific executable (i.e., a launcher). Thereafter, as shown in block 614, the application developer generates a device specific application responsive to the mobile-device type and the data representation. The device specific application is then available to forward to a destination device. Example destination devices include a mobile device, an Internet coupled data store, or a data store coupled to the computing device hosting the application developer.

Block 616 illustrates an optional feature available to an operator of the application developer. As indicated, the operator can select or otherwise identify a second mobile-device type that differs from the mobile-device type indicated in input/output block 604. In response to the selection, the data responsive to the platform independent files is forwarded to a second device-specific translator. The second device-specific translator is used to generate a second device-specific application different from the device-specific application generated in block 612 without having to regenerate an instruction set.

Any process descriptions or blocks in the flow diagrams presented in FIGS. 5 and 6 should be understood to represent modules, segments, or portions of code or logic, which include one or more executable instructions for implementing specific logical functions or blocks in the associated process. Alternate implementations are included within the scope of the present computing device and methods in which functions may be executed out of order from that shown or discussed, including substantially concurrently or in reverse order, depending on the functionality involved, as would be understood by those reasonably skilled in the art after having become familiar with the teachings described above.

The foregoing description has been presented for purposes of illustration and description. It is not intended to be exhaustive or to limit the scope of the claims to the precise forms disclosed. Modifications or variations are possible in light of the above teachings. The embodiments discussed, however, were chosen and described to enable one of ordinary skill to utilize various embodiments of the method for generating platform independent code. All such modifications and variations are within the scope of the appended claims when interpreted in accordance with the breadth to which they are fairly and legally entitled.

We claim:

1. A method for developing platform independent code, comprising:
integrating an interface into a software development platform;
receiving an input indicative of a first developer desired mobile-device type designated to receive an application responsive to a platform independent code, the mobile-device type identifying an operator interface on the mobile device;
enabling a user to develop an instruction set via the interface and the software development platform;
generating a set of platform independent files responsive to the operator interface and the instruction set;
forwarding the set of platform independent files to a device translator configured to identify configuration options and native code responsive to the mobile-device type; and
forwarding the configuration options, native code, and platform independent files to a first device-specific packager to generate a device-specific application responsive to the mobile-device type and the platform independent files.

2. The method of claim 1, wherein integrating an interface comprises adding a plug-in that exposes the functionality of a software development platform to a developer of an application suited for execution on the desired mobile device.

3. The method of claim 1, wherein receiving an input comprises an indicator associated with at least one of a personal digital assistant, a phone, a media player, and a pager.

4. The method of claim 1, wherein receiving an input comprises defining a mobile-device specific operator interface.

5. The method of claim 1, wherein receiving an input comprises defining a mobile-device specific operating system.

6. The method of claim 1, wherein enabling a user to develop an instruction set comprises providing a user-selectable mode.

7. The method of claim 6, wherein the user-selectable mode comprises bifurcating mobile-device specific interface logic from other logic.

8. The method of claim 1, wherein generating a set of platform independent files comprises producing at least one of a resource string file, a resource property pool file, a reference file, and a code file.

9. The method of claim 1, wherein forwarding the set of platform independent files comprises communicating the set with an executable specific to the operating system used on the first developer desired mobile-device type.

10. The method of claim 1, wherein generating a device-specific application comprises retaining data responsive to the set of platform independent files.

11. The method of claim 10, further comprising:
selecting a second mobile-device type different from the first developer desired mobile-device type;
forwarding the data responsive to the set of platform independent files to a second device-specific packager; and
generating a device-specific application responsive to the second mobile-device type and the data responsive to the platform independent files.

12. A mobile device, comprising:
means for executing a previously installed application comprising a virtual machine and runtime;
means for receiving a package comprising a device independent representation of an application program designated for operation on the mobile device with a mobile-device specific application program; and
means for controllably executing the mobile-device specific application program such that the device independent representation is forwarded to and executed by the previously installed application on the mobile device.

13. The mobile device of claim 12, wherein the means for receiving comprises a communication interface.

14. The mobile device of claim 13, wherein the means for receiving comprises a media interface.

15. The mobile device of claim 12, wherein the means for receiving comprises a communication session with a data store.

16. A computing device, comprising:
a processor;
a memory coupled to the processor having stored therein:
logic configured to expose the functions of a software development platform to a user of the computing device, wherein the logic is responsive to an intermediate language source and configuration options associated with a mobile device remote from the computing device;
logic configured to generate a virtual machine instruction format representation of a set of instructions designated for execution on the mobile device;
logic configured to transform the configuration options and virtual machine instruction format representation into a data portion and identify native code responsive to a mobile-device type; and
logic configured to package the data portion and the native code to generate a mobile-device specific application.

17. The computing device of claim 16, wherein the logic configured to expose the functions of a software development platform comprises a plug-in.

18. The computing device of claim 16, wherein the logic configured to generate a virtual machine instruction format produces a set of platform independent files.

19. The computing device of claim 16, wherein the native code identified by the logic configured to transform the virtual machine instruction format is configured to locate a client application on a remote mobile device.

20. The computing device of claim 16, wherein the logic configured to package the data portion and the native code is responsive to an operating system operable on a target mobile device.
